(19) United States
(12) Patent Application Publication
(10) Pub. No.: US 2008/0215423 A1
(43) Pub. Date: Sep. 4, 2008

(54) Method for Exchanging Mileage for Game Money and Method and Apparatus for Game Service in an Airplane

(76) Inventor: Chang-Joo Kim, Seoul (KR)

Correspondence Address: MERCHANT & GOULD PC, P.O. BOX 2903, MINNEAPOLIS, MN, 55402-0903, US

(21) Appl. No.: 11/722,316

(22) PCT Filed: Dec. 21, 2005
(86) PCT No.: PCT/KR2005/004437

§ 371 Date: Mar. 21, 2008

(30) Foreign Application Priority Data
Dec. 21, 2004 (KR) 10-2004-0109632

(51) Int. Cl. G06Q 30/00; A63F 9/24

(52) U.S. Cl. 705/14; 463/42

(57) ABSTRACT

Disclosed is a method for exchanging mileage for game money and a game service method and system in an airplane using the above method. More particularly, disclosed is a method for a passenger of an airplane to exchange his/her own mileage for a game money to be used in the airplane, and a game service method and system in an airplane that allows a passenger, having exchanged mileage for a game money to be used in the airplane, to enjoy game along or together with other passengers in the airplane using the above game money through each client terminal installed to each seat in the airplane and connected to an in-flight game server by a local area network.

### BACKGROUND OF THE INVENTION

1. Field of the Invention

The present invention relates to a method for exchanging mileage for game money and a game service method and system in an airplane using the above method, and more particularly to a method for a passenger of an airplane to exchange his/her own mileage for a game money to be used in the airplane, and a game service method and system in an airplane that allows a passenger, having exchanged mileage for a game money to be used in the airplane, to enjoy game along or together with other passengers in the airplane using the above game money through each client terminal installed to each seat in the airplane and connected to an in-flight game server by a local area network.

2. Description of the Related Art

Recently, Boeing, an airplane manufacturer, shows an Internet-based airplane such as Boeing 800 series, and promotes so that passengers may use Internet in airplanes traveling over the world, after 2005. Owing to the information communication infrastructure constructed in an airplane, it is possible to improve convenience of passengers further, but it should be understood that simple construction of the information communication infrastructure is not connected directly to improved convenience of passengers. That is to say, satisfaction of passengers is not enhanced just by giving simple and passive contents such as weather information or guidance of convenient facilities in an airplane. Thus, it is required for sufficient software that may utilize the information communication infrastructure constructed in an airplane.

As a scheme for utilizing the information communication infrastructure constructed in an airplane, it may be instanced to provide network-based game and shopping contents that may be enjoyed in an airplane. A long distance flight may be a monotonous time to passengers. Thus, if a plurality of passengers may enjoy network-based interactive game through client terminals installed to each seat and connected with each other, the passengers may be joyful in spite of a long distance flight. As a game contents, simple and attractive game such as a card game which may be easily practiced by most passengers is suitable selected. Card games such as Gostop game or poker currently enjoyed much may be selected, and also casino game or sports games such as golf game may also be served.

In case of Republic of Korea, mileages of airline companies such as Korean Air and Asiana Airlines are enormously accumulated over 3 thousand billion wons in total in the end of 2003, and as the mileages are accumulated more, the airline companies will be more pressed on their business since the mileage is not different from cash for the airline companies. Thus, each airline company recently proposed a desperate countermeasure of reducing free riding by mileage, but it is apparent that passengers will resist against a policy that gives disadvantages to passengers by reducing a substantial scale of the mileage. Accordingly, the mileage system that is selected as a scheme for enhancing loyalty of passengers results in lowering passengers loyalty instead.

Therefore, there is an urgent need for a method for exchanging mileage for game money and a game service method and system using the above method in an airplane so as to give software for substantially improving convenience of passengers by utilizing the information communication infrastructure constructed in an airplane, agreeably consume mileages without being contrary to the profit of users, and also derive a way for creating a new basis for profits of an airline company.

### SUMMARY OF THE INVENTION

The present invention is designed in correspondence to the above needs, and therefore it is an object of the present invention to provide a method for a passenger of an airplane to exchange mileage for game money that may be used in the airplane, and a game service method and system that allows a passenger who exchanges mileage for game money to enjoy games using the game money alone or together with other passengers through each client terminal installed to each seat of the airplane and connected to an in-flight game server by a local area network.

In order to accomplish the above object, the present invention provides a method for exchanging mileage with game money that may be used in an airplane, which includes (a) providing a passenger accessing to an on-line issuing system of an airline company with a first mileage data related to an accumulated mileage of the passenger, which is stored in a first database of the on-line issuing system; (b) converting a second mileage data for a part or all of the accumulated mileage into a first game money data for a game money to be used in the airplane at a first exchange ratio determined by the airline company according to an intension of the passenger and then storing the first game money data in the first database, when the passenger purchases a flight ticket of the airline company; (c) transmitting the first game money data stored in the first database to a second database of a first airport server of a departure airport corresponding to the flight ticket of the passenger, and then transmitting the first game money data from the second database to a third database of a game server in a specific airplane of the departure airport corresponding to the flight ticket of the passenger; (d) updating the first game money data into a second game money data when the passenger rides on the airplane and uses a game service using the game money so that the first game money data is changed into the second game money data; and (e) transmitting the second game money data to a fourth database of a second airport server of an arrival airport when the airplane arrives at the arrival airport, then transmitting the second game money data from the fourth database to the first database so that the first game money data is updated to the second game money data in the first database. Furthermore, after the step of (e), the method may further include (f) converting again the second game money data to a third mileage data of the passenger at a second exchange ratio determined by the airline company according to an intension of the passenger, and then updating the first mileage data into a fourth mileage data that is generated by adding a mileage value not converted into the game money from the accumulated mileage to a mileage value corresponding to the third mileage data.

A passenger may access to the on-line issuing system directly through Internet or via a call center or an agency. In any case, the passenger is connected to a server of an airport, called an on-line issuing system, and is provided with data related to an accumulated mileage.

In another aspect of the invention, there is provided a system for giving game service to passengers in an airplane, which includes an on-line issuing system of an airline company, a departure airport server, an in-flight game server and an arrival airport server, wherein the on-line issuing system of the airline company processes data related to issuance of a flight ticket in correspondence to a flight ticket issuing request signal of each passenger through a data communication network electrically connected to a client terminal of the passenger, calculates mileage data related to an accumulated mileage of each passenger registered in the airline company, converts a part or all of the accumulated mileage of each passenger into a game money data related to game money that may be used in the airplane at a first exchange ratio determined by the airline company, and includes a first database storing the mileage data of each passenger before or after the conversion and the game money data, wherein the departure airport server includes a second database storing information related to the processed data related to flight ticket issuance of each passenger, transmitted from the first database through a data communication network electrically connected to the on-line issuing system, the mileage data related to an accumulated mileage of each passenger and the game money data related to the game money, the departure airport server transmitting the information related to the processed data related to flight ticket issuance of each passenger, the mileage data and the game money data, stored in the second database, to the in-flight game server, wherein the in-flight game server includes a third database, is electrically connected to a plurality of client terminals provided to each seat in the airplane through a local area network, receives the information related to the processed data related to flight ticket issuance of each passenger, the mileage data and the game money data from the departure airport server, stores the information related to the processed data related to flight ticket issuance of each passenger, the mileage data and the game money data in the third database provided in the airplane, and executes at least one game application on the in-flight game server based on the game money data of each passenger stored in the third database so as to provide game service to passengers in the airplane through the plurality of client terminals connected to the in-flight game server, and wherein, after the airplane arrives at an arrival airport, the arrival airport server receives the mileage data and the game money data of each passenger stored in the second database through a data communication network electrically connected to the in-flight game server at a predetermined time interval, stores the mileage data and the game money data in a fourth database, and transmits the mileage data and the game money data to the on-line issuing system through a data communication network electrically connected to the on-line issuing system so that the on-line issuing system updates the mileage data and the game money data of each passenger stored in the first database.

At this time, the in-flight game server preferably further includes a product database storing product selling information and a shopping mall application so that a passenger purchases a specific product with his/her own residual game money when the product selling information is displayed to the passenger via the client terminal by means of the shopping mall application executed on the in-flight game server after the game service is ended.

Furthermore, the game application of the in-flight game server may be a multi-user network game application provided through at least two client terminals accessing the game application.

In still another aspect of the invention, there is also provided a system for providing game service in an airplane, which includes an in-flight game server having a passenger-mileage database and a game application, and client terminals connected to the in-flight game server through a local area network, wherein the passenger-mileage database includes data related to mileage of each passenger who executes the game application through the client terminal, wherein the game application is provided in a form of a single-user game or a multi-user battle game to passengers, and wherein the in-flight game server updates mileage information of a passenger in the passenger-mileage database whenever the game application is executed once by the passenger.

In another aspect of the invention, there is also provided a method for providing game service in an airplane, which includes a logging-in step for an account of a passenger to be logged in an in-flight game server by inputting logging-in ID and password of the passenger through a client terminal; a game selection step for the passenger to select a game on the in-flight game server; a game fee deducting step for deducting a predetermined game fee from a second game money just before every execution of the selected game; and a game execution step for executing the selected game after the game fee is deducted.

At this time, the method may further include a shopping step for executing a shopping mall application and allowing the passenger to purchase a product on the shopping mall application with a residual game money, after the execution of the game.

As another embodiment, the present invention provides a method for providing game service in an airplane, which includes a logging-in step for an account of a passenger to be logged in an in-flight game server by inputting logging-in ID and password of the passenger through a client terminal; a game selection step for the passenger to select a game on the in-flight game server; a game execution step for executing the game; and a game fee deducting step for deducting a predetermined game fee from a second game money just after execution of the game.

The method may further include purchasing a deducted and accumulated game fee after the game is ended, by means of access from an outside of the airplane.

### BRIEF DESCRIPTION OF THE DRAWINGS

FIG. 1 is a diagram showing the whole configuration of an in-flight game service system according to the present invention;

FIG. 2 shows a configuration inside an airplane of the in-flight game service system according to the present invention;

FIGS. 3 and 4 are block diagrams illustrating an in-flight game service method according to the present invention;

FIG. 5 shows a logging-in screen according to the in-flight game service method according to one embodiment of the present invention;

FIG. 6 shows a game money exchanging screen according to the in-flight game service method according to one embodiment of the present invention;

FIG. 7 shows a game selection screen according to the in-flight game service method according to one embodiment of the present invention;

FIG. 8 shows a single-user/multi-user selection screen according to the in-flight game service method according to one embodiment of the present invention;

FIG. 9 shows a game mode selection screen for a multi-user game according to the in-flight game service method according to one embodiment of the present invention;

FIG. 10 shows a partner selection screen according to the in-flight game service method according to one embodiment of the present invention;

FIG. 11 shows a game execution screen according to the in-flight game service method according to one embodiment of the present invention;

FIG. 12 shows a shopping mall application execution screen after execution of a game according to the in-flight game service method according to one embodiment of the present invention; and

FIG. 13 is a flowchart illustrating the in-flight game service method according to one embodiment of the present invention.

### DESCRIPTION OF THE PREFERRED EMBODIMENT

Hereinafter, the present invention will be described in more detail referring to the drawings.

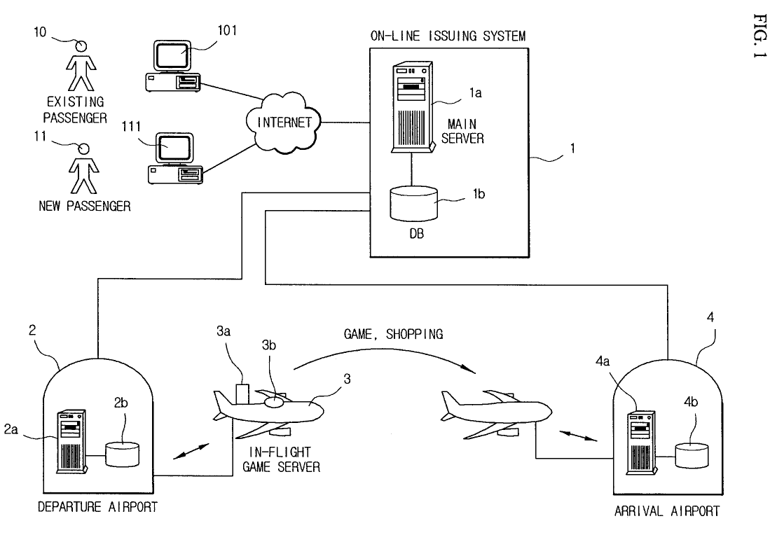

FIG. 1 shows the overall configuration of an in-flight game service system according to the present invention.

As shown in FIG. 1, the in-flight game service system according to the present invention includes an on-line issuing system 1 of an airline company, a departure airport server 2, an in-flight game server 3 and an arrival airport server 4.

The departure airport server 2 and the arrival airport server 4 are installed to all airports to which the in-flight game service system according to the present invention is applied, and one airport server may acts as a departure airport server or an arrival airport server depending on a flight direction of the in-flight game server 3. In addition, all airport servers are always connected to the on-line issuing system 1 of an airline company via a network such as a dedicated line so as to process information related to works such as passenger-mileage information and issuance information in real time.

In case an existing passenger 10 or a new passenger 11 accesses to the on-line issuing system 1 of an airline company using his/her own PC 101, 111 connected to Internet and then requests flight ticket issuance or conversion of mileage into game money, the on-line issuing system 1 of an airline company processes related works using a main server 1a. For this purpose, the main server 1a refers a passenger-mileage database 1b, which stores mileage data related to an accumulated mileage of each passenger. It would be understood that the new passenger 11 needs further procedures for registering his/her own logging-in ID and password.

In case a passenger requests to convert mileage into game money, the main server 1a converts a part or all of the accumulated mileage into a game money data related to game money to be used in an airplane at a predetermined exchange ratio determined by the airline company according to the request of passenger, and then stores the game money data in the passenger-mileage database. At this time, the exchange ratio may be varied according to the policy of the airline company, and thus one game money may be endowed for one mile for example, or a different exchange ratio may be applied. It is also possible that the exchange ratio is differentiated for each passenger according to a loyalty index of the passenger for the airline company by adopting CRM technique.

The game money generated by conversion of the mileage utilized for the passenger to enjoy game or shopping during flight after the passenger rides on an airplane.

Then, the departure airport server 2 accesses the on-line issuing system 1 and receives and processes data related to passengers who depart from the airport server 2a of the departure airport 2. That is to say, the departure airport server 2 receives information related to the processed data related to flight ticket issuance from the on-line issuing system 1, and then processes general works related to passenger's riding on the airplane. Also, the departure airport server 2 accesses the in-flight game server 3a of the airplane 3 that the passenger is to ride on, and then temporarily stores information related to mileage and game money of the passenger until the passenger-mileage database 2b storing the data received from the departure airport server 1a to the in-flight game server 3a is synchronized with a passenger-mileage database 3b of the in-flight game server 3a.

If the airplane 3 arrives at the departure airport 2, the departure airport server 2a is connected to the in-flight game server 3a, and then the passenger-mileage database 2b is synchronized with the passenger-mileage database 3b till the airport takes off.

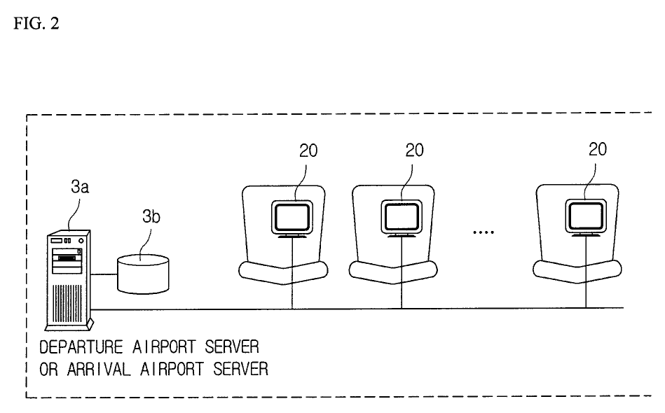

Then, the in-flight game server 3a provides passengers with service such as game or shopping through the client terminals based on touch screens installed to each seat on the basis of the passenger-mileage database 3b synchronized by the departure airport server 2a while the airplane 3 flies from the departure airport 2 to the arrival airport 4. Detailed description for the in-flight game server 3a will be given with reference to FIG. 2.

Then, after the airplane 3 arrives at the arrival airport 4, the arrival airport server 4 synchronizes the passenger-mileage database 3b, which is changed since the passenger uses the service such as game or shopping, with a passenger-mileage database 4b of the arrival airport 4, and then synchronizes the passenger-mileage database 4b with the passenger-mileage database 1b of the on-line issuing system 1 again so that changes of the game money during flight may be reflected on the on-line issuing system 1.

FIG. 2 shows an inner configuration of the airplane in the in-flight game service system according to the present invention in more detail.

As shown in FIG. 2, the inner configuration of the airplane in the in-flight game service system according to the present invention includes the in-flight game server 3a, the passenger-mileage database 3b and a plurality of client terminals 20 connected to the in-flight game server 3a by a network.

The in-flight game server 3a provides various kinds of game service to passengers depending on the game money information of each passenger, stored in the passenger-mileage database, and it deducts a game fee from the game money whenever a game is played. In addition, the game application may be a single-user type game application or a multi-user type game application. Among them, in case a multi-user type game application is played, the in-flight game server 3a plays a role of providing environments for network play among passengers riding in the same airplane.

Furthermore, the in-flight game server 3a may further include a shopping mall application and store selling data of duty-free products that are sold in the airplane, for example. Accordingly, the shopping mall application is provided after a passenger finishes the game service or at an interval between games played by the passenger so that the passenger may check the selling formation of products through the client terminal 20 and purchase a specific product with his/her own residual game money. The product selling data stored in the passenger-mileage database 3b is synchronized together when the passenger-mileage database 3b is synchronized with the passenger-mileage database 2b, 4b of the departure or arrival airport so that stock data or in-flight purchase data may be reflected on the passenger-mileage database 1b of the on-line issuing system 1.

The client terminal 20 used in the in-flight game service system according to the present invention has the following specification.

The client terminal 20 is defined as a personal client terminal installed to a rear side of a back of each front passenger seat. The client terminal 20 has a 7″ or 11″ LCD monitor as an output means, and has a touch screen positioned in front of the LCD monitor and a joystick for processing commands that are not easily input by the touch screen.

In addition, the game contents may be any game contents that is generally executed based on PC, but card game (e.g., poker, blackjack and Hula), slot machine, Mah-jongg, Flower cards and so on, which may attract much interests from various passenger groups and are in a category promoting consumption of the game money of passengers. In addition, sports game contents such as golf are more preferable in consideration of main passengers of airplanes.

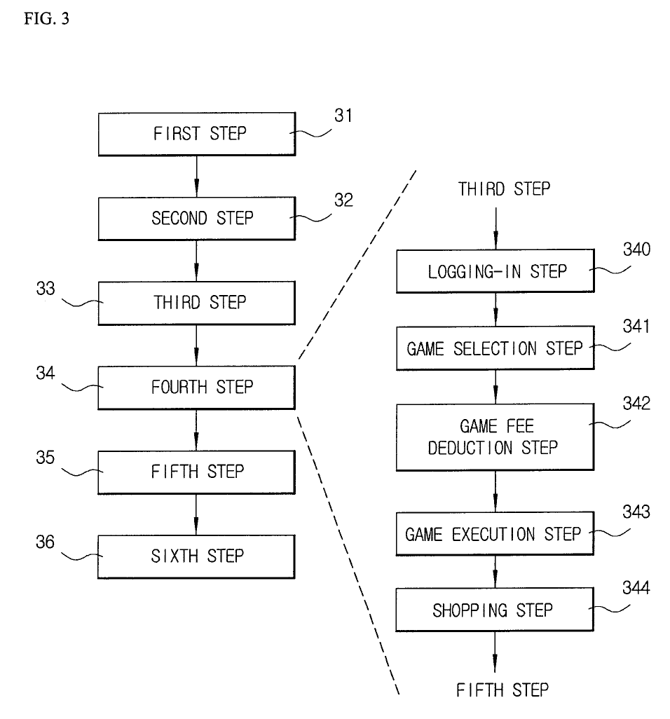

FIG. 3 is a block diagram illustrating an in-flight game service method according to the present invention.

In the block diagram of FIG. 3, a left part illustrates an overall flow from a point that a passenger accesses the on-line issuing system to a point that changes of data generated when a passenger rides on an airplane and plays a game are reflected again on the on-line issuing system.

Among them, a fourth step related to game service accomplished in an airplane may be classified in more detail as shown in a right part of FIG. 3 into a logging-in step 340, a game selection step 341, a game fee deduction step 342, a game execution step 343 and a shopping step 344.

In the logging-in step 340, a passenger inputs logging-in ID and password through the client terminal to log in the in-flight game server. At this time, other schemes may also be considered, and for example a passenger may log in using other means such as a flight ticket serial code instead of the logging-in ID.

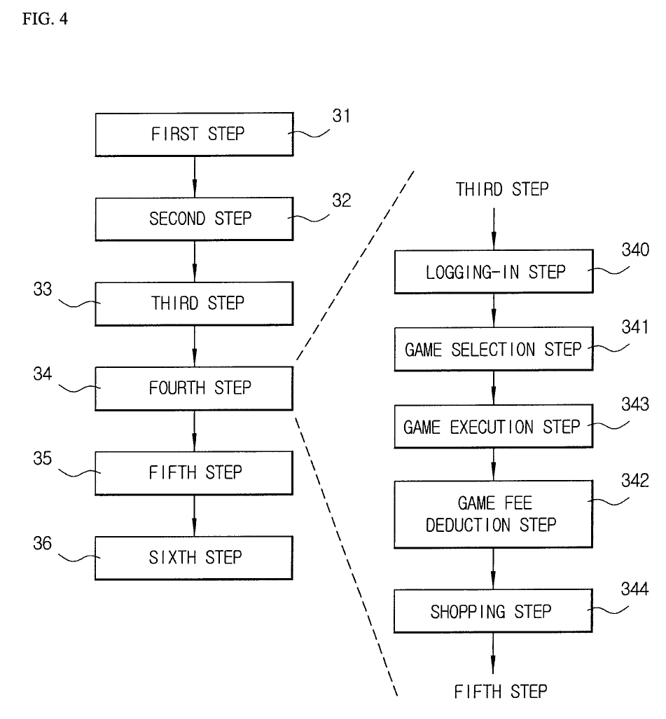

FIG. 4 is also a block diagram illustrating the in-flight game service method according to the present invention. In FIG. 4, the game fee deduction step 342 is shown after the game execution step 343, in order to consider the case that a game fee should be deducted after the game execution step due to the nature of the game.

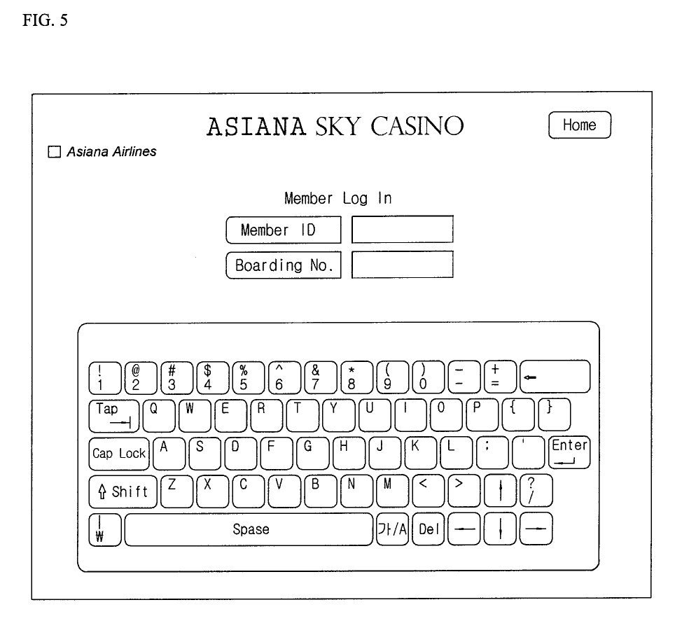

FIG. 5 shows one example of a screen in the logging-in step 340, output to the client terminal of the passenger according to the in-flight game service method of the present invention.

Then, in the game selection step 341, a logged-in passenger selects a game on the in-flight game server. As mentioned above, various kinds of games may be provided through the in-flight game server, so it is required for the passenger to select a game that the passenger wants to play.

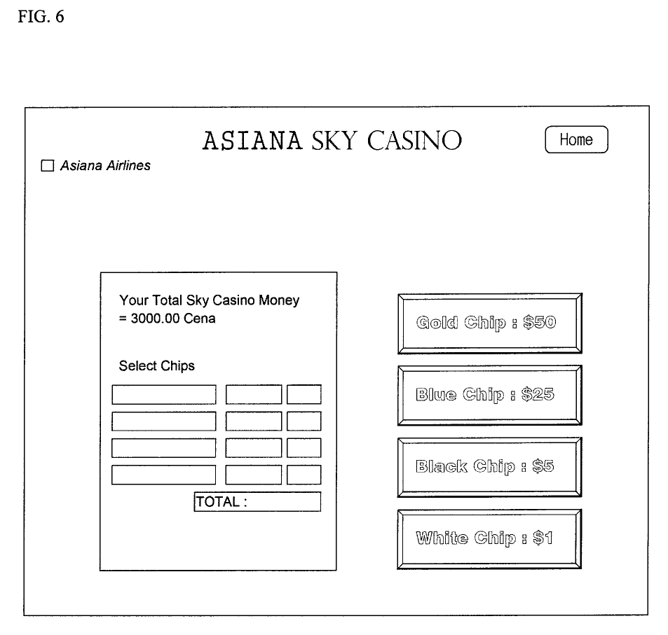

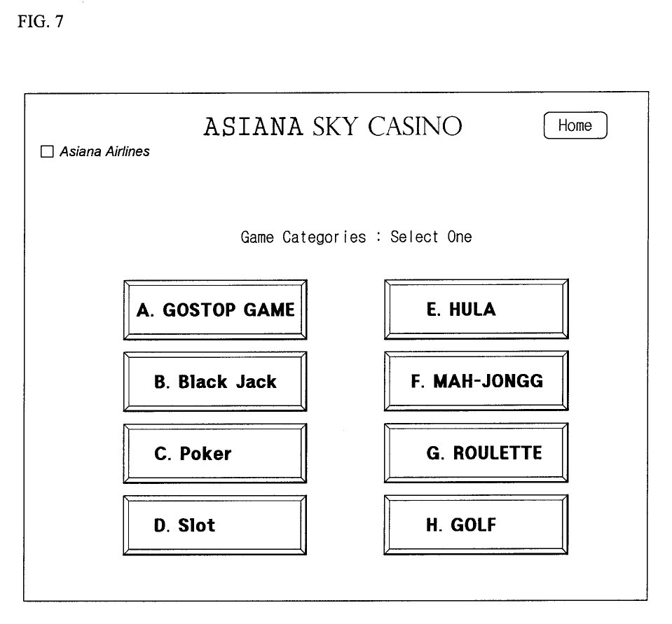

FIG. 6 shows one example of a screen of the game selection step 341, output on the client terminal of a passenger according to the in-flight game service method of the present invention.

Meanwhile, since it is required to exchange the game money into a different kind of game money such as a casino money, after a game to be used by the passenger is specified in the game selection step 341, a game money exchange screen as shown in FIG. 6 may be displayed according to one embodiment of the present invention.

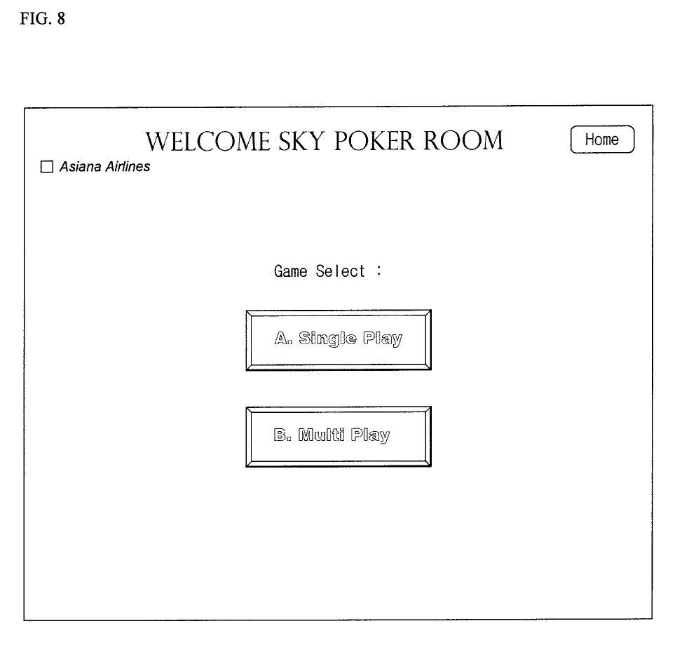

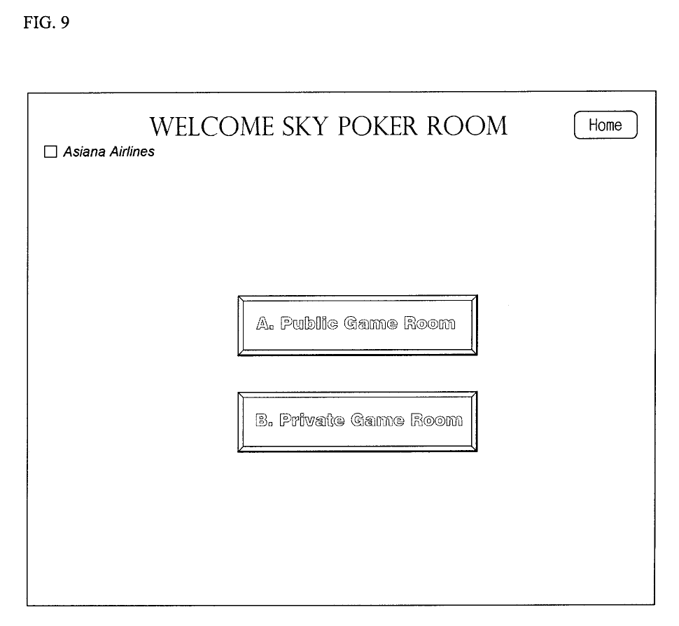

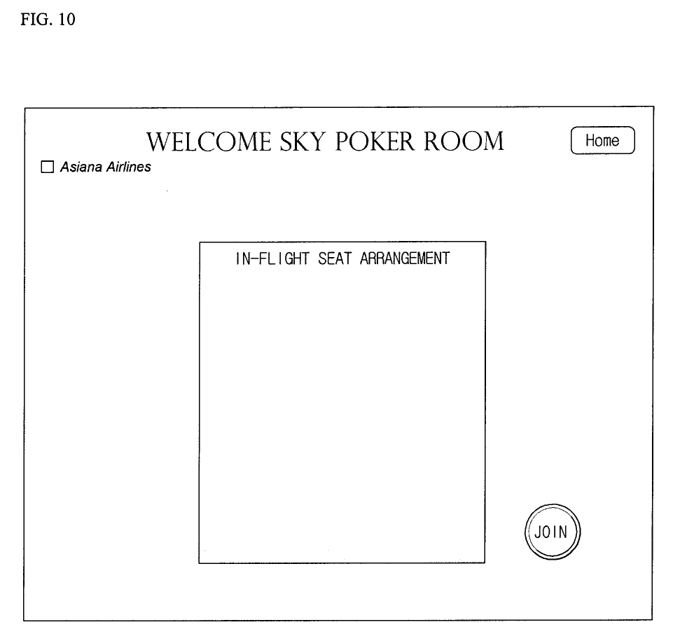

Similarly, a single-user/multi-user selection screen as shown in FIG. 8 may be output in one embodiment of the present invention so that a passenger may select a game in a desired category in advance among single-user type games and multi-user type games. In addition, in case a multi-user game such as a poker game is selected, a game mode selection screen as shown in FIG. 9 may be output to select a desired one of game rooms in which the passenger may play the game with persons well acquainted or with unspecified persons in the airplane. A partner selection screen according to an embodiment in which the passenger plays a game with a specified partner is shown in FIG. 10. In addition, in case of a slot machine game, a passenger may select a single play mode, and the passenger plays the game with an airline company (or, a dealer or computer). Additionally, in case of a blackjack, the passenger plays the game with multi users and a house (or, a dealer or airline company) though the game is a multi-user game.

Then, in the game fee deduction step 342, a predetermined game fee is deducted from the game money of the passenger after the passenger selects a game but before playing the game. A deduction ratio and amount of the game fee may be varied, but the game fee deduction step 342 is directed to reducing a part of the game money of the passenger as a price of the game service and then reducing the mileage of the passenger that is a basis of the game money. In this consideration, the game fee deduction step 342 is preferably executed whenever a game is played.

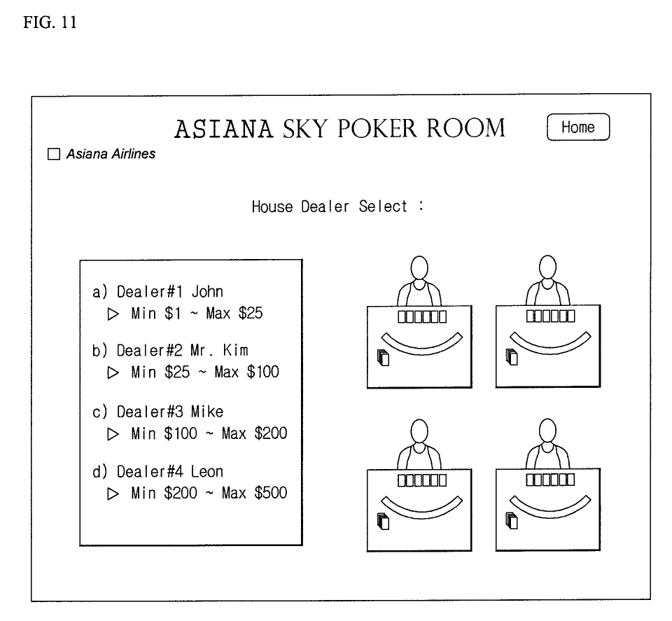

After a game fee is deducted in the game fee deduction step 342, a game execution step 343 for executing a game selected by a passenger is executed. FIG. 11 shows a screen on which a poker game is executed as an example of the in-flight game service method of the present invention.

However, the game fee deduction step may be executed before or after the game execution step. In case a passenger plays a single-user golf game against a computer or plays a multi-user golf game against other users, a caddy fee at a predetermined ratio or amount may be paid by the passenger in advance so that the game fee deduction step is executed before the game execution step. However, in case of a card game such as blackjack and poker or a slot machine game, a predetermined percentage of the entire stakes or a predetermined amount may be paid by the user as a dealer fee. In case of a card game, the dealer fee is preferably paid when each game is ended.

As being expected from FIG. 11, in the game execution step, a game money may be transferred between passengers due to the nature of each game. Such changes of game money are successively stored in the passenger-mileage database so that, when the airplane lands at the arrival airport, the passenger-mileage database is synchronized with the passenger-mileage database of the arrival airport server and the changes are reflected on the passenger-mileage database of the on-line issuing system.

Meanwhile, after finishing a selected game, the passenger may use a shopping mall to purchase duty-free products with a residual game money in the airplane according to the intension of the passenger and the policy of the airline company.

For purchasing a product in the shopping mall, the passenger may use his/her residual game money. However, in case a residual game money is smaller than a purchase price of the product that the passenger wishes to purchase in the shopping mall, a mileage that is possessed by the passenger but not exchanged for game money may be used together in view of the aim of the present invention. The details related to the mileage of passenger is managed in the passenger-mileage database of the in-flight game server. Similarly, if technical solution is provided for using a credit card, it may also be considered that a credit card is used together with the game money and the mileage for purchasing products in the in-flight shopping mall.

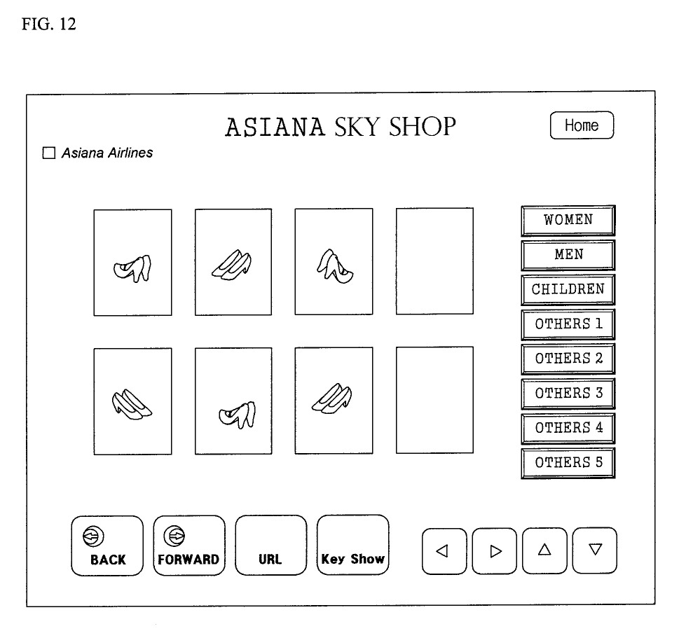

FIG. 12 shows a shopping mall application screen shown after a game is executed, in the in-flight game service method according to one embodiment of the present invention.

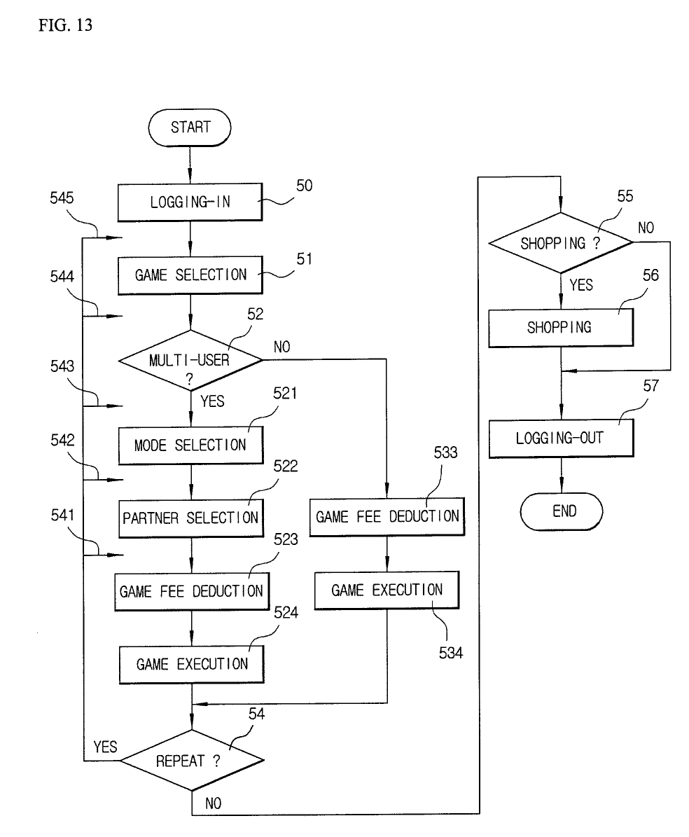

FIG. 13 is a flowchart illustrating an in-flight game service method according to one embodiment of the present invention.

As shown in FIG. 13, if a passenger logs in the in-flight game server through a client terminal (step 50), the passenger selects a desired game (step 51) through the game selection screen as shown in FIG. 5.

In case the game selected by the passenger is a multi-user type game, a list of games corresponding to a category of multi-user type games is output on the client terminal, while, in case a single-user type game is selected, a list of games corresponding to a category of single-user type games is output (step 52). If the selected game may be used as both a single-user type and a multi-user type, game lists of two categories may be all displayed.

If the passenger selects a multi-user type game, the passenger selects one of multi-user type games ad also selects a game mode (step 521), and selects a game partner (step 522), and then if the game is executed (step 524) together with game fee deduction (step 523), the passenger may play the game.

Similarly, if the passenger selects one of single-user type games, as the game is executed (step 534) together with game fee deduction (step 533), the passenger may play the game.

Since it is generally not expected that a passenger plays the game only once after logging in, a menu 54 for allowing the passenger to play the game repeatedly may be considered. In this step, the passenger may determine whether to play the same game again with the same partner (step 541), select a new partner (step 542), use the game in a different mode (step 543), change the kind of game in the same category (step 544), play a new game in a different category (step 545), or quit using the game.

In case a passenger wants to quit the game, it is determined whether or not to execute a shopping mall application according to the selection of the passenger or the policy of the airline company (step 55).

In case the passenger decides to use the shopping mall (step 56), the shopping mall application as shown in FIG. 12 is executed so that the passenger may purchase duty-free products in the airplane with his/her residual game money.

After the passenger uses the shopping mall or in case the passenger decides not to use the shopping mall, a logging-out step (step 57) is executed for the passenger to quit the access to the in-flight game server.

After the logging-out step (step 57), the passenger may use the in-flight game service according to the present invention from the first by logging-in (step 50).

If the passenger quits the access to the in-flight game server, this information is transmitted to the main server through the arrival airport after arriving at the arrival airport, and the passenger may check the information on-line after that. However, there may be a time delay of about one day for the passenger to check the information in consideration of physical transmission time or the like.

In addition, if a payment system that allows the passenger to make a payment by cash or card after consuming all mileage of the passenger is adopted, a dispute related to a gambling spirit may be caused. Thus, a direct mileage purchasing system in an airplane is intentionally excluded. However, a mileage deducted as a dealer fee or the like from the passenger by an airline company or an operator of the above system is stored, and this mileage may be sold by direct access of the passenger after a certain time, not in the airplane, so as to get a profit.

Various embodiments of the method for exchanging mileage for game money and the in-flight game service method and system using the above method according to the present invention have been described, but it should be understood that the above description does not intend to limit the spirit of the invention, defined in the appended claims, to specific examples.

### APPLICABILITY TO THE INDUSTRY

By using the method for exchanging mileage for game money and also the in-flight game service method and system according to the present invention, a passenger who exchanges mileage for game money to be used in an airplane may enjoy game along or together with other passengers in the airplane through each client terminal installed to each seat of the airplane and connected to the in-flight game server b using the game money, and also consumption of the mileage is promoted.

1. A method for exchanging mileage with game money that may be used in an airplane, the method comprising:
(a) providing a passenger accessing to an on-line issuing system of an airline company with a first mileage data related to an accumulated mileage of the passenger, which is stored in a first database of the on-line issuing system;
(b) converting a second mileage data for a part or all of the accumulated mileage into a first game money data for a game money to be used in the airplane at a first exchange ratio determined by the airline company according to an intension of the passenger and then storing the first game money data in the first database, when the passenger purchases a flight ticket of the airline company;
(c) transmitting the first game money data stored in the first database to a second database of a first airport server of a departure airport corresponding to the flight ticket of the passenger, and then transmitting the first game money data from the second database to a third database of a game server in a specific airplane of the departure airport corresponding to the flight ticket of the passenger;
(d) updating the first game money data into a second game money data when the passenger rides on the airplane and uses a game service using the game money so that the first game money data is changed into the second game money data; and
(e) transmitting the second game money data to a fourth database of a second airport server of an arrival airport when the airplane arrives at the arrival airport, then transmitting the second game money data from the fourth database to the first database so that the first game money data is updated to the second game money data in the first database.

2. The method for exchanging mileage for game money according to claim 1, further comprising, after the step of (e):
(f) converting again the second game money data to a third mileage data of the passenger at a second exchange ratio determined by the airline company according to an intension of the passenger, and then updating the first mileage data into a fourth mileage data that is generated by adding a mileage value not converted into the game money from the accumulated mileage to a mileage value corresponding to the third mileage data.

3. A system for giving game service to passengers in an airplane, which includes an on-line issuing system of an airline company, a departure airport server, an in-flight game server and an arrival airport server:
wherein the on-line issuing system of the airline company processes data related to issuance of a flight ticket in correspondence to a flight ticket issuing request signal of each passenger through a data communication network electrically connected to a client terminal of the passenger, calculates mileage data related to an accumulated mileage of each passenger registered in the airline company, converts a part or all of the accumulated mileage of each passenger into a game money data related to game money that may be used in the airplane at a first exchange ratio determined by the airline company, and includes a first database storing the mileage data of each passenger before or after the conversion and the game money data,
wherein the departure airport server includes a second database storing information related to the processed data related to flight ticket issuance of each passenger, transmitted from the first database through a data communication network electrically connected to the on-line issuing system, the mileage data related to an accumulated mileage of each passenger and the game money data related to the game money, the departure airport server transmitting the information related to the processed data related to flight ticket issuance of each passenger, the mileage data and the game money data, stored in the second database, to the in-flight game server,
wherein the in-flight game server includes a third database, is electrically connected to a plurality of client terminals provided to each seat in the airplane through a local area network, receives the information related to the processed data related to flight ticket issuance of each passenger, the mileage data and the game money data from the departure airport server, stores the information related to the processed data related to flight ticket issuance of each passenger, the mileage data and the game money data in the third database provided in the airplane, and executes at least one game application on the in-flight game server based on the game money data of each passenger stored in the third database so as to provide game service to passengers in the airplane through the plurality of client terminals connected to the in-flight game server, and
wherein, after the airplane arrives at an arrival airport, the arrival airport server receives the mileage data and the game money data of each passenger stored in the second database through a data communication network electrically connected to the in-flight game server at a predetermined time interval, stores the mileage data and the game money data in a fourth database, and transmits the mileage data and the game money data to the on-line issuing system through a data communication network electrically connected to the on-line issuing system so that the on-line issuing system updates the mileage data and the game money data of each passenger stored in the first database.

4. The system for providing game service to passengers in an airplane according to claim 3, wherein the in-flight game server further includes a product database storing product selling information and a shopping mall application so that a passenger purchases a specific product with his/her own residual game money when the product selling information is displayed to the passenger via the client terminal by means of the shopping mall application executed on the in-flight game server after the game service is ended.

5. The method for providing game service to passengers in an airplane according to claim 3, wherein the game application of the in-flight game server is a multi-user network game application provided through at least two client terminals accessing the game application.

6. A system for providing game service in an airplane, which includes an in-flight game server having a passenger-mileage database and a game application, and client terminals connected to the in-flight game server through a local area network:
wherein the passenger-mileage database includes data related to mileage of each passenger who executes the game application through the client terminal,
wherein the game application is provided in a form of a single-user game or a multi-user battle game to passengers, and
wherein the in-flight game server updates mileage information of a passenger in the passenger-mileage database whenever the game application is executed once by the passenger.

7. A method for providing game service in an airplane, comprising:
a logging-in step for an account of a passenger to be logged in an in-flight game server by inputting logging-in ID and password of the passenger through a client terminal;
a game selection step for the passenger to select a game on the in-flight game server;
a game fee deducting step for deducting a predetermined game fee from a second game money just before every execution of the selected game; and
a game execution step for executing the selected game after the game fee is deducted.

8. A method for providing game service in an airplane, comprising:
a logging-in step for an account of a passenger to be logged in an in-flight game server by inputting logging-in ID and password of the passenger through a client terminal;
a game selection step for the passenger to select a game on the in-flight game server;
a game execution step for executing the game; and
a game fee deducting step for deducting a predetermined game fee from a second game
money just after execution of the game.

9. The method for providing game service in an airplane according to claim 7, further comprising:
a shopping step for executing a shopping mall application and allowing the passenger to purchase a product on the shopping mall application with a residual game money, after the execution of the game.

10. The method for providing game service in an airplane according to claim 7, further comprising:
purchasing a deducted and accumulated game fee after the game is ended, by means of access from an outside of the airplane.
